(19) United States
(12) Patent Application Publication
(10) Pub. No.: US 2026/0139574 A1
(43) Pub. Date: May 21, 2026

(54) Multifactorial optimization method for deep coal and rock gas pressure return nozzles

(71) Applicant: Southwest Petroleum University, Chengdu City, SC (US)

(72) Inventors: Qiang WANG, Chengdu City (CN); Haotian FENG, Chengdu City (CN); Hailong CHEN, Chengdu City (CN); Yufeng WANG, Chengdu City (CN); Xiaowei LI, Chengdu City (CN); Yuanbo LI, Chengdu City (CN); Qilong WU, Chengdu City (CN)

(73) Assignee: Southwest Petroleum University, Chengdu City, SC (US)

(21) Appl. No.: 19/446,900

(22) Filed: Jan. 12, 2026

(30) Foreign Application Priority Data
Jan. 14, 2025 (CN) 202510052879.2

(51) Int. Cl. E21B 43/00; E21B 43/267

(52) U.S. Cl. CPC E21B 43/006; E21B 43/267; E21B 2200/20

(57) ABSTRACT

This invention discloses an optimization method for flowback nozzles in deep coal and rock gas formations, considering the influence of multiple factors, belonging to the field of coal and rock gas extraction technology. Addressing the challenge of flowback fluid velocity control in deep coal and rock gas development, this method establishes models for matrix and fracture seepage and two-phase flow within the wellbore. It comprehensively considers the migration of pulverized coal and proppant, as well as the influence of coal seam cleavage fractures, to optimize wellhead nozzle size, reduce the probability of pulverized coal clogging fractures, and improve fracture conductivity. Compared to traditional methods, this invention has significant advantages in improving fracturing efficiency and high-efficiency coal and rock gas extraction, providing an innovative solution for the scientific research and engineering applications of deep coal and rock gas.

### TECHNICAL FIELD

This invention belongs to the field of unconventional natural gas development technology and relates to a method for controlling deep coal and rock gas pressure return nozzles that takes into account the effects of coal powder, proppant migration and coal seam cleavage fractures.

### BACKGROUND

With the continuous deepening of coalbed methane exploration and exploitation in China, deep coalbed methane development has become a strategic replacement resource for increasing natural gas reserves and production in China. Therefore, how to efficiently and rationally exploit coalbed methane is a new challenge we face. Under the influence of high pressure and temperature, the adsorption capacity of coal in China's deep coalbed methane reservoirs reaches its limit, forming supersaturated deep coalbed methane reservoirs with “high gas content, high saturation, and free gas content”. Due to the influence of its reservoir characteristics, hydraulic fracturing technology has been widely used in the development of coalbed methane. After coal seam fracturing, timely flowback is essential to reduce the residence time of fracturing fluid in the reservoir and minimize damage to the coal seam. Furthermore, due to the inherent fragility of coal seams, coal dust is easily generated during coal-rock reservoir and mining processes. This dust can clog flow channels within fractures, reducing fracture conductivity and significantly impacting coal-rock gas production. Therefore, controlling the flowback fluid velocity during coal-rock gas flowback to prevent coal dust from flowing within the reservoir matrix and expelling it from the fractures, thereby improving fracture conductivity, is crucial for efficient deep coal-rock gas extraction. Mechanistically, extensive research has been conducted both domestically and internationally on coal dust production and reservoir damage mechanisms, two-phase flow, post-fracturing fracturing fluid flowback, and proppant recirculation. However, a systematic model coupling nozzle, wellbore, reservoir, proppant, and coal dust transport has not yet been established, and an integrated flowback optimization system has not been provided. In engineering practice, the flowback rate of the fracturing fluid is mainly controlled by empirically adjusting the nozzle size, thereby controlling the settling and placement of the proppant.

Domestic and foreign scholars have conducted some research on nozzle control during the post-fracturing flowback process; currently, the optimization of nozzles after fracturing is mainly carried out for shale gas, conventional reservoirs and shallow coalbed methane; for coalbed methane, some scholars have considered the characteristics of immediate sedimentation of proppant and cementation between particles after fracturing of coalbed methane wells, and established a fracturing fluid flowback model, and used the purpose of preventing proppant backflow to control and adjust the nozzle (Zhang Zhuang; Post-fracturing flowback technology of coalbed methane wells; J. Coalfield Geology and Exploration, 2017, 45(5):70-74); other scholars have considered the adsorption and desorption characteristics and seepage mechanism of coalbed methane, and found that situations such as excessively fast drainage of coalbed methane wells, well washing and repair, well shutdown, and liquid level below the top surface of the coal seam are prone to contamination, resulting in a sharp reduction in gas and water production. Based on the characteristics and mechanisms of damage, and combined with years of drainage experience, a drainage system was established, which includes constant pressure drainage, control of reasonable working pressure difference, and control of appropriate coal powder production. This formula is only related to pore radius and pore morphology, but does not consider the migration of proppant and coal powder in the fracture, as well as the flow in the wellbore and nozzle, and does not establish an optimization model for wellhead nozzle control (Zhang Suian, Cao Lihu, Du Caixia; Research on gas production mechanism and drainage pressure and powder control in coalbed methane wells; Journal of Coal Science and Technology, 2014, 39(9): 1928-1931). In addition, some scholars have analyzed the differences in geological conditions between Yanchuan South and Qinnan coalbed methane, and established a corresponding drainage system based on the field drainage parameters of Yanchuan South coalbed methane wells; the study divided the drainage system of deep coalbed methane reservoirs in Yanchuan South coalbed methane field into 5 drainage stages, namely: rapid pressure reduction stage, stable pressure reduction stage, production increase stage, production fluctuation stage and stable production stage, and constructed a refined drainage control method based on the bottom pressure drop corresponding to each stage; however, since the bottom pressure drop is difficult to monitor and control, and the influence of proppant, coal powder and reservoir is not considered, this study still has significant shortcomings (Zhao Xinglong, Tang Dazhen, Zhang Yan; Establishment and optimization of drainage system for deep coalbed methane reservoirs in Yanchuan South coalbed methane field; J. Coal Science and Technology, 2021, 49(6):251-257). In addition, some scholars have also considered the migration of proppant and coal powder in fractures, constructed an artificial fracture-wellbore-nozzle flow system, studied the theory of coal powder initiation and proppant backflow control, and established a mathematical model for calculating the size of the flowback nozzle after coalbed methane well pressure; however, this theory does not consider the changes in liquid phase state, the influence of fracture closure and the influence of the real reservoir during the flowback process (Zhao Qihong; Thesis; Research on the determination method of flowback nozzle size after coalbed methane well pressure; Southwest Petroleum University, Chengdu, 2017).

Analysis of past studies reveals that most optimizations for post-fracturing flowback focus on controlling bottom hole pressure drop, but monitoring and controlling bottom hole pressure drop is a difficult process with significant implementation challenges. Studies on nozzle control often consider only a single influencing factor or lack a comprehensive understanding of all factors. Overall, current research lacks a holistic system framework, hindering the widespread adoption of current nozzle optimization methods. Since a complete optimization method for post-fracturing nozzle dimensions that fully considers proppant, coal dust transport, multiphase flow, and reservoir variations has not yet been established for deep coal-bearing gas, it is necessary to construct a new optimization system and method. To achieve this, we established a seepage model of the deep coal-bearing tight gas matrix and fractures, as well as a two-phase steady-state flow model within the wellbore, based on seepage mechanics, elasticity, fluid mechanics, and a dual-porosity media model (as shown in FIG. 1). Considering the changes in formation pressure after fracturing, which lead to differences in proppant stress, we established stress models for proppant and minimum critical flow velocity models for proppant initiation during fracturing fluid flowback, as well as a critical flow velocity model for pulverized coal initiation within the fracture. This resulted in the development of a complete optimization method for deep coal-bearing tight gas flowback nozzles after fracturing.

### SUMMARY

This invention proposes a novel wellhead nozzle optimization method for the flowback process after fracturing in deep coal and gas formations. Based on seepage mechanics, elasticity, fluid mechanics, and a dual-porosity media model, this method considers seepage within the matrix and fractures, two-phase steady-state flow within the wellbore, and the stress differences of the proppant and pulverized coal after hydraulic fracturing. Corresponding mathematical models are established for each, ultimately constructing a completely new method for optimizing the nozzle size during flowback in deep coal and gas formations after fracturing. Using this method, the relationship between the wellhead nozzle and wellhead pressure during the flowback process can be obtained based on the input basic construction and reservoir parameters. This method incorporates all the physical properties of deep coal and gas formations and represents a significant innovation in the research of deep coal and gas flowback control theory, providing valuable reference for scientific research and engineering applications.

The technical solution provided by this invention to solve the above-mentioned technical problems is: an optimization method for deep coal and rock gas pressure return nozzle considering the influence of multiple factors, comprising the following steps:
(1) Based on the dual-pore medium model, a multi-stage multi-cluster fracturing—flowback model was established to continuously simulate the two processes of injection and production. The physical behavior of the two-phase flow during fracturing and flowback was characterized by adjusting the fracturing fluid rate during injection and production.
(2) Establish flow models of nozzle and wellbore systems, and use the principle of material balance to establish the pressure transmission relationship between these two and the fracturing-flowback model;
(3) Establish a critical flow model for proppant and pulverized coal within the fracture;
(4) By using the relationship between the critical flow rate of the nozzle and the nozzle size obtained in step (2), the reservoir IPR curve obtained in step (1), and the critical flow rates corresponding to the proppant start-up and the coal powder start-up in the fracture obtained in step (3), the nozzle size range under a certain formation pressure is determined.
(5) As the flowback time increases, the formation pressure decreases and the phase changes. The reservoir IPR curve and the critical flow velocity corresponding to proppant initiation and coal powder initiation in fracture will also change. Repeat step (4) to obtain the new nozzle size range after the formation pressure decreases. Integrate the wellhead pressure at this time with the optimized nozzle size to obtain the relationship between nozzle size and wellhead pressure after fracturing of the well.

A further technical solution is to establish a multi-stage, multi-cluster fracturing-flowback model based on a dual-porosity medium model, continuously simulating both injection and production processes. By adjusting the fracturing fluid rate during injection and production, the fracturing-flowback flow process is simulated. The fracturing-flowback model is shown below:

$$∇ \cdot [ \frac{{k}_{f} {k}_{r g f}}{{μ}_{f g} {B}_{f g}} ∇ ( {p}_{f g} - {ρ}_{f g} g H ) ] + {q}_{gmf}^{*} - {q}_{v g} = \frac{\partial }{\partial t} ( \frac{{ϕ}_{f} {S}_{f g}}{{B}_{f g}} ) \qquad ( 1 )$$

$$∇ \cdot [ \frac{{k}_{f} {k}_{r w f}}{{μ}_{fw} {B}_{f w}} ∇ ( {p}_{f w} - {ρ}_{fw} g H ) ] + {q}_{w m f}^{*} - {q}_{v w} = \frac{\partial }{\partial t} ( \frac{{ϕ}_{f} {S}_{f w}}{{B}_{f w}} ) \qquad ( 2 )$$

$$- {q}_{g m f}^{*} + {q}_{ν m} = \frac{\partial }{\partial t} ( \frac{{ϕ}_{m} {S}_{m g}}{{B}_{m g}} ) \qquad ( 3 )$$

$$- {q}_{w m f}^{*} = \frac{\partial }{\partial t} ( \frac{{ϕ}_{m} {S}_{m w}}{{B}_{m w}} ) \qquad ( 4 )$$

In the formula, ∇ represents the gradient operator symbol (dimensionless); a represents the partial differential symbol, (dimensionless); t represents time, (s); φ_{f} represents fracture porosity, (dimensionless); k_{f} represents fracture permeability, (10⁻³ μm²); p_{fg} and p_{fw} represent the gas and water phase pressures in the fracture system, respectively (MPa); μ_{fg} and μ_{fw} represent the viscosity of gas and water in the fracture system, respectively (mPa·s); k_{rgf} and k_{rwf} represent the relative permeability of gas and water in the fracture system, (dimensionless); ρ_{fg} and ρ_{fw} represent the density of gas and water in the fracture system, respectively (kg/m³): g represents gravitational acceleration, taken as g=9.8 m/s²; H represents formation depth (m); B_{fg} and B_{fw} represent the gas and water phase volume coefficients in the fracture system (dimensionless); S_{fg} and S_{fw} represent the gas and water phase saturation in the fracture system (dimensionless); q_{vg} and q_{vw} represent the gas and water production per unit volume of coal reservoir, respectively (m³/(m³·s)); q*_{gmf} and q*_{wmf} represent the gas and water phase exchange rates between the fracture and matrix pore systems, respectively (m³/(m³·s)); φₘ represents the matrix porosity (dimensionless); S_{mg} and S_{mw} represent the gas and water phase saturation rates in the matrix pore system, respectively (dimensionless); B_{mg} and B_{mw} represent the gas and water volume coefficients within the matrix pores, respectively (dimensionless); qᵥₘ represents the flow rate of desorbed gas from the matrix pore surface to the matrix pores (m³/(m³·s)).

A further technical solution is that the specific process of step (2) is as follows: establish a flow model of the nozzle and wellbore system, and use the principle of material balance to establish the pressure transmission relationship between these two and the fracturing-flowback model:

a. Gas-Liquid Two-Phase Flow Model for Oil Nozzles:

$${q}_{L} = {c}_{1} {d}_{0}^{{c}_{2}} {R}_{p}^{- {c}_{3}} {p}_{1} \qquad ( 5 )$$

$${d}_{2} = {d}_{1} / \sqrt{{q}_{L 1} / {q}_{L 2}} \qquad ( 6 )$$

In the formula, q_{L} is the fluid flow rate, m³/d; d₀ is the nozzle diameter (mm); Rₚ is the production gas-oil ratio (m³/m³); p₁ is the nozzle inlet pressure (MPa); c₁, c₂, and c₃ are empirical coefficients (dimensionless); d₁ and d₂ are the nozzle dimensions before and after the operating system adjustment (mm); q_{L1} and q_{L2} are the well fluid production before and after the operating system adjustment (m³/d).

b. Calculation Model for Two-Phase Flow Pressure Inside the Wellbore:

$$- ( \frac{d p}{d z} ) = {ρ}_{m} g sin θ + \frac{{τ}_{w} {S}_{p}}{A} + \frac{{ρ}_{m} {ν}_{m} d {ν}_{m}}{dz} \qquad ( 7 )$$

$${ρ}_{m} = {ρ}_{g} ( 1 - {H}_{L} ) + {ρ}_{L} {H}_{L} \qquad ( 8 )$$

In the formula, d is the differential symbol; μm is the density of the gas-liquid mixture (kg/m³); sin is the sine function (dimensionless); θ is the wellbore inclination angle (°); g is the gravitational acceleration (m/s²); τ_{w} is the shear stress between the mixture and the inner wall of the wellbore (MPa); Sₚ is the wetted perimeter of the wellbore (m); A is the cross-sectional area of the wellbore (m²); vₘ is the flow velocity of the gas-liquid two-phase mixture (m/s); μ_{g} is the gas phase density, (kg/m³); μ_{L} is the liquid phase density (kg/m³); and H_{L} is the liquid holdup of the wellbore section (dimensionless).

A further technical solution is that the specific process of step (3) is as follows: establish a critical flow model of proppant and coal powder in the fracture of deep coal-rock gas reservoir, and the specific formula is as follows:

a. Critical Flow Rate of the Proppant:

$${ν}_{c 1} = {( \frac{2}{55.5} {d}_{c}^{1.6} g \frac{{ρ}_{c} - ρ}{{ρ}^{0.4} {μ}^{0.6}} )}^{\frac{5}{7}} \qquad ( 9 )$$

In the formula, v_{cl} is the critical flow velocity of the proppant (m/s); ρ_{c} is the particle density (kg/m³) d_{c} is the particle diameter (m); p is the fluid density (kg/m³); μ is the fluid viscosity (mPa·s); g is the acceleration due to gravity, taken as g=9.8 m/s²;

b. Critical Flow Rate of Pulverized Coal:

$${ν}_{c 2} = \frac{{d}_{c}^{τ}}{12 ( 1 + \sqrt{3} ) μ} [ ( {p}_{c} - p ) + \frac{2 {d}_{c} g ( {ρ}_{c} - ρ )}{3} + \frac{\sqrt{3} ε}{8 {d}_{c}} ] \qquad ( 10 )$$

In the formula, v_{c2} is the critical flow velocity of pulverized coal (m/s); ε is the cohesion coefficient, taken as 2.56 dyn/cm; p_{c} is the pressure of the fracture wall on the proppant (MPa); p is the fluid pressure inside the fracture (MPa); and r is a specific constant (dimensionless).

A further technical solution is that the specific process of step (4) is as follows: based on the model established in steps (1) to (3), the relationship between the critical flow rate of the nozzle and the nozzle size, the reservoir IPR curve (the relationship between the bottom pressure difference and the flow rate) and the critical flow velocity corresponding to the start-up of proppant and the start-up of coal powder in the fracture are obtained, and the nozzle size range d_{c1} to d_{c2} under a certain formation pressure is determined (as shown in FIG. 2).

A further technical solution is that the specific process of step (5) is as follows: as the flowback time increases, the formation pressure decreases, the phase state will change, and the critical flow rates corresponding to the reservoir IPR curve and the proppant initiation and the coal powder initiation in the fracture will also change accordingly. Repeating step (4) can obtain the new nozzle size range after the formation pressure decreases. By integrating the corresponding wellhead pressure with the optimized nozzle size, the relationship between the nozzle size and the wellhead pressure after fracturing of the well can be obtained (as shown in FIG. 3).

This invention proposes a novel method for optimizing wellhead nozzles during the flowback process after fracturing in deep coal and rock gas formations. Based on seepage mechanics, elasticity, fluid mechanics, and a dual-porosity media model, we established a seepage model of the tight gas matrix and fractures in deep coal-bearing formations, as well as a two-phase steady-state flow model within the wellbore. Based on the stress model of the proppant within the fractures, we constructed a minimum critical velocity model for proppant activation during fracturing fluid flowback, and simultaneously established a critical velocity model for coal powder activation within the fractures. Finally, we constructed a complete optimization method for wellhead nozzles during the flowback process of deep coal and rock gas formations after fracturing. This method is superior to traditional methods, considering the main characteristics of the formation, fractures, wellbore, and nozzles during the flowback process of deep coal and rock gas formations after fracturing. It represents a significant innovation in the research of the control theory of deep coal and rock gas flowback after fracturing, providing scientific and reasonable guidance for this process and having important engineering significance for improving fracturing efficiency.

### BRIEF DESCRIPTION OF THE DRAWINGS

FIG. 1 is a schematic diagram of the nozzle-wellbore-reservoir coupling proposed in this invention;

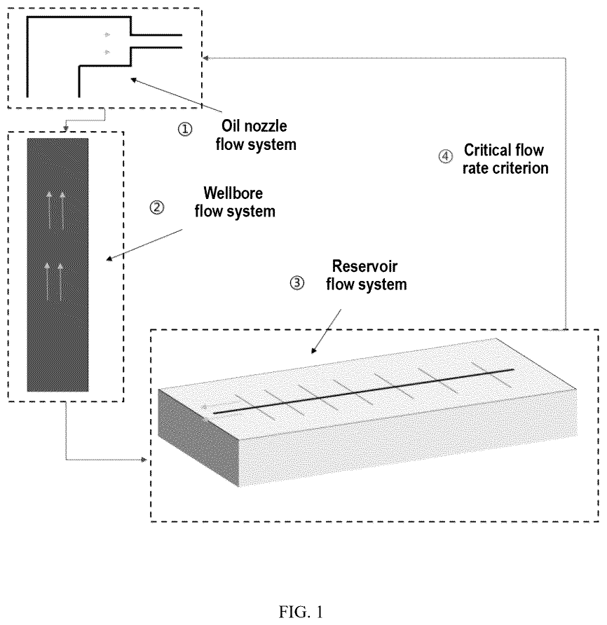

FIG. 2 shows the relationship between wellhead pressure, flow rate and nozzle size at a certain moment;

FIG. 3 shows the relationship between the post-pressure return wellhead pressure and the optimal nozzle size of a deep coal and rock gas well.

FIG. 4 is a schematic diagram of the simulated physical model of the embodiment.

### DETAILED DESCRIPTION OF EMBODIMENTS

To make the objectives, technical solutions, and advantages of the present invention clearer, the present invention will be further illustrated below with reference to the accompanying drawings and embodiments.

An optimization method for deep coal and rock gas pressure return nozzles considering multiple factors includes the following steps:

1) of this invention, a multi-stage, multi-cluster fracturing-flowback model needs to be established based on a dual-porosity medium model to continuously simulate the injection and production processes. The fracturing fluid rate during injection and production is adjusted to simulate the fracturing-flowback flow process.

$$∇ \cdot [ \frac{{k}_{f} {k}_{r g f}}{{μ}_{f g} {B}_{f g}} ∇ ( {p}_{f g} - {ρ}_{f g} g H ) ] + {q}_{gmf}^{*} - {q}_{v g} = \frac{\partial }{\partial t} ( \frac{{ϕ}_{f} {S}_{f g}}{{B}_{f g}} ) \qquad ( 1 )$$

$$∇ \cdot [ \frac{{k}_{f} {k}_{r w f}}{{μ}_{fw} {B}_{f w}} ∇ ( {p}_{f w} - {ρ}_{fw} g H ) ] + {q}_{w m f}^{*} - {q}_{v w} = \frac{\partial }{\partial t} ( \frac{{ϕ}_{f} {S}_{f w}}{{B}_{f w}} ) \qquad ( 2 )$$

$$- {q}_{g m f}^{*} + {q}_{ν m} = \frac{\partial }{\partial t} ( \frac{{ϕ}_{m} {S}_{m g}}{{B}_{m g}} ) \qquad ( 3 )$$

$$- {q}_{w m f}^{*} = \frac{\partial }{\partial t} ( \frac{{ϕ}_{m} {S}_{m w}}{{B}_{m w}} ) \qquad ( 4 )$$

In the formula, ∇ represents the gradient operator symbol (dimensionless); ∂ represents the partial differential symbol, (dimensionless); t represents time, (s); φ_{f} represents fracture porosity, (dimensionless); k_{f} represents fracture permeability, (10⁻³ μm²); p_{fg} and p_{fw} represent the gas and water phase pressures in the fracture system, respectively (MPa); μ_{fg} and μ_{fw} represent the viscosity of gas and water in the fracture system, respectively (mPa's); k_{rgf} and k_{rwf} represent the relative permeability of gas and water in the fracture system, (dimensionless); ρ_{fg} and ρ_{fw} represent the density of gas and water in the fracture system, respectively (kg/m³): g represents gravitational acceleration, taken as g=9.8 m/s²; H represents formation depth (m); B_{fg} and B_{fw} represent the gas and water phase volume coefficients in the fracture system (dimensionless); S_{fg} and S_{fw} represent the gas and water phase saturation in the fracture system (dimensionless); q_{vg} and q_{vw} represent the gas and water production per unit volume of coal reservoir, respectively (m³/(m³·s)); q′gmf and q′wmf represent the gas and water phase exchange rates between the fracture and matrix pore systems, respectively (m³/(m³·s)); Om represents the matrix porosity (dimensionless); S_{mg} and S_{mw} represent the gas and water phase saturation rates in the matrix pore system, respectively (dimensionless); B_{mg} and B_{mw} represent the gas and water volume coefficients within the matrix pores, respectively (dimensionless); qᵥₘ represents the flow rate of desorbed gas from the matrix pore surface to the matrix pores (m³/(m³·s)).

2) of this invention, a flow model of the nozzle and wellbore system is established, and the pressure transmission relationship between these two systems and the fracturing-flowback model is established using the principle of material balance.

a. Gas-Liquid Two-Phase Flow Nozzle Flow Model:

$${q}_{L} = {c}_{1} {d}_{0}^{{c}_{2}} {R}_{p}^{- {c}_{3}} {p}_{1} \qquad ( 5 )$$

$${d}_{2} = {d}_{1} / \sqrt{{q}_{L 1} / {q}_{L 2}} \qquad ( 6 )$$

In the formula, q_{L} is the fluid flow rate, m³/d; d₀ is the nozzle diameter (mm); Rₚ is the production gas-oil ratio (m³/m³); p₁ is the nozzle inlet pressure (MPa); c₁, c₂, and c₃ are empirical coefficients (dimensionless); d₁ and d₂ are the nozzle dimensions before and after the operating system adjustment (mm); q_{L1} and q_{L2} are the well fluid production before and after the operating system adjustment (m³/d).

b. Calculation Model for Two-Phase Flow Pressure Inside the Wellbore:

$$- ( \frac{d p}{d z} ) = {ρ}_{m} g sin θ + \frac{{τ}_{w} {S}_{p}}{A} + \frac{{ρ}_{m} {ν}_{m} d {ν}_{m}}{dz} \qquad ( 7 )$$

$${ρ}_{m} = {ρ}_{g} ( 1 - {H}_{L} ) + {ρ}_{L} {H}_{L} \qquad ( 8 )$$

In the formula, d is the differential symbol; μₘ is the density of the gas-liquid mixture (kg/m³); sin is the sine function (dimensionless); θ is the wellbore inclination angle (°); g is the gravitational acceleration (m/s²); τw is the shear stress between the mixture and the inner wall of the wellbore (MPa); Sₚ is the wetted perimeter of the wellbore (m); A is the cross-sectional area of the wellbore (m²); vₘ is the flow velocity of the gas-liquid two-phase mixture (m/s); μ_{g} is the gas phase density, (kg/m³); μ_{L} is the liquid phase density (kg/m³); and H_{L} is the liquid holdup of the wellbore section (dimensionless).

In this invention, step (3) is to establish a critical flow model of proppant and coal powder within fractures of deep coal-rock gas reservoirs, the specific expression of which is as follows:

a. Critical Flow Rate of the Proppant:

$${ν}_{c 1} = {( \frac{2}{55.5} {d}_{c}^{1.6} g \frac{{ρ}_{c} - ρ}{{ρ}^{0.4} {μ}^{0.6}} )}^{\frac{5}{7}} \qquad ( 9 )$$

In the formula, v_{c1} is the critical velocity of the proppant (m/s); ρ_{c} is the particle density (kg/m³); d_{c} is the particle diameter (m); ρ is the fluid density (kg/m³); μ is the fluid viscosity, (mPa·s); g is the gravitational acceleration, taken as g=9.8 m/s²;

b. Critical Flow Rate of Pulverized Coal:

$${ν}_{c 2} = \frac{{d}_{c}^{τ}}{12 ( 1 + \sqrt{3} ) μ} [ ( {p}_{c} - p ) + \frac{2 {d}_{c} g ( {ρ}_{c} - ρ )}{3} + \frac{\sqrt{3} ε}{8 {d}_{c}} ] \qquad ( 10 )$$

v_{c2} is the critical velocity of the pulverized coal (m/s); ε is the cohesion coefficient, taken as 2.56 dyn/cm; p_{c} is the pressure of the fracture wall on the proppant (MPa); p is the fluid pressure inside the fracture (MPa); τ is a specific constant (dimensionless).

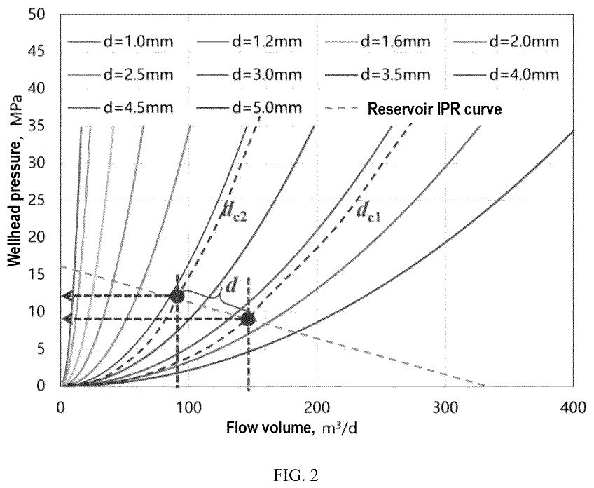

In this invention, step (4) is to obtain the relationship between the critical flow rate of the nozzle and the nozzle size, the reservoir IPR curve (the relationship between bottom hole pressure difference and flow rate) and the critical flow velocity corresponding to the proppant start-up and the coal powder start-up in the fracture based on the model established in steps (1) to (3), and determine the nozzle size range under a certain formation pressure, as shown in FIG. 2. The obtained nozzle range is d_{c1}˜d_{c2}.

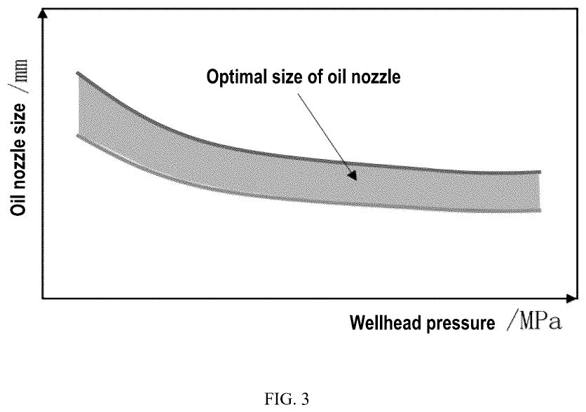

In this invention, step (5) considers that the increase in flowback time will lead to a decrease in formation pressure, which will cause a phase change and thus affect the reservoir IPR curve and the critical flow velocity corresponding to proppant initiation and coal powder initiation in fractures; repeating step (4) can obtain a new nozzle size range after the formation pressure decreases, and integrate the corresponding wellhead pressure with the optimized nozzle size, as shown in FIG. 3, to obtain the relationship between nozzle size and wellhead pressure after fracturing of the well.

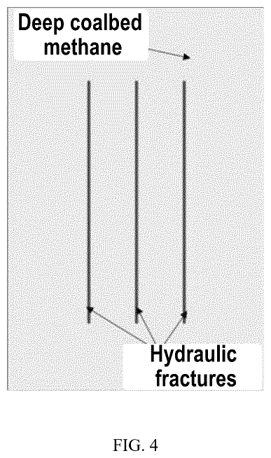

Example 1: This example uses a deep coal-gas reservoir in the Ordos Basin as the implementation object. The Ordos Basin has abundant deep coal-gas. Geological data of this block was obtained through field logging and well testing, and the obtained parameters are representative. The schematic diagram of the simulation physical model is shown in FIG. 4. The specific simulation method steps are as follows:
1. Geological parameters obtained through field logging and well testing: burial depth 2789 m; pressure coefficient 0.95; thickness 10 m; permeability 4md; porosity 0.08; average cluster spacing 18 m; casing diameter 139.7 mm; proppant density 2700 kg/m³; proppant diameter 0.6 mm; fracturing fluid viscosity 10 mPa·s; water saturation 0.6; coal powder concentration 0.02 m³/m³; coal powder density 1400 kg/m³.
2. Substitute all geological parameters into the established model, i.e., formulas (1) to (10), to obtain the relationship between the critical flow rate and nozzle size, the reservoir IPR curve (the relationship between bottom hole pressure difference and flow rate), and the critical flow velocities corresponding to proppant initiation and pulverized coal initiation in fractures, thus determining the nozzle size range under a certain formation pressure. Repeat the above steps to obtain the new nozzle size range after the formation pressure is reduced. Integrate the corresponding wellhead pressure with the optimized nozzle size to obtain the distribution of formation pressure, water saturation, and the relationship between nozzle size and wellhead pressure during the flowback process after fracturing of the well.

The above description is not intended to limit the present invention in any way. Although the present invention has been disclosed through the above embodiments, it is not intended to limit the present invention. Any person skilled in the art can make some changes or modifications to the above-disclosed technical content to create equivalent embodiments without departing from the scope of the present invention. Any simple modifications, equivalent changes and modifications made to the above embodiments based on the technical essence of the present invention without departing from the scope of the present invention shall still fall within the scope of the present invention.

1. A multifactorial optimization method for deep coal and rock gas pressure return nozzles, characterized by comprising the following main steps:
(1) Based on the dual-porosity medium model, a multi-stage, multi-cluster fracturing-flowback model is established to continuously simulate the injection and production processes. The physical behavior of the gas-liquid two-phase flow during fracturing and flowback is characterized by adjusting the fracturing fluid rate during injection and production. The model specifically includes the following equations:
$$∇ [ \frac{{k}_{f} {k}_{r g f}}{{μ}_{f g} {B}_{f g}} ∇ ( {p}_{f g} - {ρ}_{f g} g H ) ] + {q}_{gmf}^{*} - {q}_{ν g} = \frac{\partial }{\partial t} ( \frac{{ϕ}_{f} {S}_{f g}}{{B}_{f g}} ) \qquad ( 1 )$$
$$∇ [ \frac{{k}_{f} {k}_{r w f}}{{μ}_{fw} {B}_{f w}} ∇ ( {p}_{f w} - {ρ}_{fw} g H ) ] + {q}_{w m f}^{*} - {q}_{ν w} = \frac{\partial }{\partial t} ( \frac{{ϕ}_{f} {S}_{f w}}{{B}_{f w}} ) \qquad ( 2 )$$
$$- {q}_{g m f}^{*} + {q}_{ν m} = \frac{\partial }{\partial t} ( \frac{{ϕ}_{m} {S}_{m g}}{{B}_{m g}} ) \qquad ( 3 )$$
$$- {q}_{w m f}^{*} = \frac{\partial }{\partial t} ( \frac{{ϕ}_{m} {S}_{m w}}{{B}_{m w}} ) \qquad ( 4 )$$
In the formula, ∇ represents the gradient operator symbol (dimensionless); ∂ represents the partial differential symbol, (dimensionless); t represents time, (s); φ_{f} represents fracture porosity, (dimensionless); k_{f} represents fracture permeability, (10⁻³ μm²); p_{fg} and p_{fw} represent the gas and water phase pressures in the fracture system, respectively (MPa); μ_{fg} and μ_{fw} represent the viscosity of gas and water in the fracture system, respectively (mPa·s); k_{rgf} and k_{rwf} represent the relative permeability of gas and water in the fracture system, (dimensionless); ρ_{fg} and ρ_{fw} represent the density of gas and water in the fracture system, respectively (kg/m³): g represents gravitational acceleration, taken as g=9.8 m/s²; H represents formation depth (m); B_{fg} and B_{fw} represent the gas and water phase volume coefficients in the fracture system (dimensionless); S_{fg} and S_{fw} represent the gas and water phase saturation in the fracture system (dimensionless); q_{vg} and q_{vw} represent the gas and water production per unit volume of coal reservoir, respectively (m³/(m³·s)); q*_{gmf} and q*_{wmf} represent the gas and water phase exchange rates between the fracture and matrix pore systems, respectively (m³/(m³·s)); φₘ represents the matrix porosity (dimensionless); S_{mg} and S_{mw} represent the gas and water phase saturation rates in the matrix pore system, respectively (dimensionless); B_{mg} and B_{mw} represent the gas and water volume coefficients within the matrix pores, respectively (dimensionless); qᵥₘ represents the flow rate of desorbed gas from the matrix pore surface to the matrix pores (m³/(m³·s)).
(2) Establish flow models of nozzle and wellbore systems, and use the principle of material balance to establish the pressure transmission relationship between these two and the fracturing-flowback model;
(3) Establish a critical flow model for proppant and pulverized coal within the fracture;
(4) By using the reservoir IPR curve obtained in step (1), the relationship between the critical flow rate and the nozzle size obtained in step (2), and the critical flow rates corresponding to the proppant initiation and the pulverized coal initiation in the fracture obtained in step (3), the nozzle size range under a certain formation pressure is determined.
(5) As the flowback time increases, the formation pressure decreases and the phase changes. The reservoir IPR curve and the critical flow rates corresponding to proppant initiation and pulverized coal initiation in fractures will also change. Repeat step (4) to obtain the new nozzle size range after the formation pressure decreases. Integrate the wellhead pressure at this time with the optimized nozzle size range to obtain the relationship between nozzle size and wellhead pressure after fracturing of the well.

2. The multifactorial optimization method for deep coal and rock gas pressure return nozzles as described in claim 1, characterized in that the flow model of the nozzle and wellbore system and the pressure transmission relationship model between the fracturing-flowback model established in step (2) specifically include:
a. Gas-liquid two-phase flow model for oil nozzles:
$${q}_{L} = {c}_{1} {d}_{0}^{{c}_{2}} {R}_{p}^{- {c}_{3}} {p}_{1} \qquad ( 5 )$$
$${d}_{2} = {d}_{1} / \sqrt{{q}_{L 1} / {q}_{L 2}} \qquad ( 6 )$$
In the formula, q_{L} is the fluid flow rate, m³/d; d₀ is the nozzle diameter (mm); Rₚ is the production gas-oil ratio (m³/m³); p₁ is the nozzle inlet pressure (MPa); c₁, c₂, and c₃ are empirical coefficients (dimensionless); d₁ and d₂ are the nozzle dimensions before and after the operating system adjustment (mm); q_{L1} and q_{L2} are the well fluid production before and after the operating system adjustment (m³/d).
b. Pressure calculation model for gas-liquid two-phase flow inside the wellbore:
$$- ( \frac{d p}{d z} ) = {ρ}_{m} g sin θ + \frac{{τ}_{w} {S}_{p}}{A} + \frac{{ρ}_{m} {ν}_{m} d {ν}_{m}}{dz} \qquad ( 7 )$$
$${ρ}_{m} = {ρ}_{g} ( 1 - {H}_{L} ) + {ρ}_{L} {H}_{L} \qquad ( 8 )$$
In the formula, dis the differential symbol; μ_{g} is the gas phase density, kg/m³; μ_{L} is the liquid phase density (kg/m³); μₘ is the density of the gas-liquid mixture (kg/m³);
sin is the sine function (dimensionless); θ is the wellbore inclination angle (°); g is the gravitational acceleration (m/s²); τ_{W} is the shear stress between the mixture and the inner wall of the wellbore (MPa); Sₚ is the wetted perimeter of the wellbore (m); A is the cross-sectional area of the wellbore (m²); vₘ is the flow velocity of the gas-liquid two-phase mixture (m); H_{L} is the liquid holdup of the wellbore section (dimensionless).

3. The multifactorial optimization method for deep coal and rock gas pressure return nozzles as described in claim 1, characterized in that the critical flow model of proppant and pulverized coal within the fractures of the deep coal gas reservoir established in step (3) includes:
$${ν}_{c 1} = {( \frac{2}{55.5} {d}_{c}^{1.6} g \frac{{ρ}_{c} - ρ}{{ρ}^{0.4} {μ}^{0.6}} )}^{\frac{5}{7}} \qquad ( 9 )$$
$${ν}_{c 2} = \frac{{d}_{c}^{τ}}{12 ( 1 + \sqrt{3} ) μ} [ ( {p}_{c} - p ) + \frac{2 {d}_{c} g ( {ρ}_{c} - ρ )}{3} + \frac{\sqrt{3} ε}{8 {d}_{c}} ] \qquad ( 10 )$$
In the formula, Vel is the critical velocity of the proppant (m/s); ρ_{c} is the particle density (kg/m³); de is the particle diameter (m); p is the fluid density (kg/m³); μ is the fluid viscosity, (mPa s); g is the gravitational acceleration, taken as g=9.8 m/s²: v_{c2} is the critical velocity of the pulverized coal (m/s); ε is the cohesion coefficient, taken as 2.56 dyn/cm; p_{c} is the pressure of the fracture wall on the proppant (MPa); p is the fluid pressure inside the fracture (MPa); τ is a specific constant (dimensionless).

4. The multifactorial optimization method for deep coal and rock gas pressure return nozzles as described in claim 1, characterized in that the specific process of step (4) is as follows: based on the model established in steps (1) to (3), the relationship between the critical flow rate of the nozzle and the nozzle size, the reservoir IPR curve and the critical flow rate corresponding to the proppant start-up and the coal powder start-up in the fracture are obtained, and the nozzle size range d_{c1}˜d_{c2} under a certain formation pressure is determined.

5. The multifactorial optimization method for deep coal and rock gas pressure return nozzles as described in claim 1, characterized in that step (5) specifically includes: considering that the increase in flowback time will lead to a decrease in formation pressure, which will cause a phase change, thereby affecting the reservoir IPR curve and the critical flow rate corresponding to proppant initiation and coal powder initiation in fractures; repeating step (4) can obtain a new nozzle size range after the formation pressure decreases, and integrating the corresponding wellhead pressure with the optimized nozzle size can obtain the relationship map between the nozzle size and wellhead pressure after fracturing of the well.
